(19) United States
(12) Patent Application Publication
(10) Pub. No.: US 2026/0300700 A1
(43) Pub. Date: Oct. 1, 2026

(54) DIFFERENTIAL QUANTIZATION OF A NEURAL NETWORK BASED ON SVD INFORMATION RANKING

(71) Applicant: Microsoft Technology Licensing, LLC, Redmond, WA (US)

(72) Inventors: Yehonathan REFAEL KALIM, Herzliya (IL); Adam HAKIM, Shoham (IL); Gilad KIRSHENBOIM, Petach Tiqva (IL)

(21) Appl. No.: 19/095,166

(22) Filed: Mar. 31, 2025

(51) Int. Cl. G06N 3/0495

(52) U.S. Cl. CPC G06N 3/0495

(57) ABSTRACT

The present invention relates to a method for differential quantization of neural networks, such as large language models (LLMs), to improve operational efficiency without significant performance degradation. The method involves decomposing a neural network layer's matrix into multiple matrices using decomposition to identify significant components and insignificant components. The significant components undergo minimal or no quantization, while the less significant components undergo higher degrees of quantization. This differential quantization allows large neural networks to operate efficiently on edge devices with limited computing resources. The differential quantization technique enhances the deployment of neural networks in various hardware environments by reducing computational and memory bandwidth demands.

### CROSS-REFERENCE TO RELATED APPLICATIONS

None.

### BACKGROUND

Neural networks are a key part of artificial intelligence and are used in a wide range of applications, from image recognition to natural language processing. Large neural networks (NNs), such as large language models (LLMs) have been widely adopted, both in academia and in the industry. A LLM is a type of artificial intelligence model that has been trained on a vast amount of text data. It may learn to predict the next word in a sentence by understanding the context provided by the preceding words. This ability allows it to generate human-like text, given an input. LLMs, such as a Generative Pre-training Transformer (GPT) model, may have billions of parameters that are fine-tuned during training, enabling them to capture complex patterns in language use. They can answer questions, write essays, summarize texts, translate languages, and even generate code. However, their increasing model complexity, manifested through billions to trillions of parameters, has presented significant challenges for their deployment and execution.

There is growing interest to deploy NNs on edge computing devices. However, some edge computing devices may lack the computing resources to perform the computations required for a LLM or other large model to produce an answer. This makes deployment to some edge devices impossible and/or impractical.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

The technology described herein is related to a differentially quantized neural network that improves operational efficiency of the neural network without significant performance degradation. Differential quantization offers an efficiency advantage whether the neural network operates on an edge device or in the cloud. The efficiency gained might enable large neural networks, like language models (LMs) (e.g., LLM, small language model (SLM)), to run on edge devices that otherwise lacked the processing capacity, memory capacity, or memory throughput to run a LM. Differential quantization performs different levels of quantization on different portions of a neural network, including different portions of a single neural network layer. Differential quantization results in values in a single layer being stored at different levels of precision. For example, a first portion of values may be stored in a floating-point format (e.g., float16) while a second portion are stored in an integer format (e.g., Int8). The objective of the differential quantization method presented here is to minimize or eliminate quantization on the most critical parts of a neural network while applying higher degrees of quantization to the less critical sections of the network. In some instances, the significant and less significant parts of a neural network can be identified through a matrix decomposition process.

A neural network layer includes a matrix of weights that plays a role in the network's ability to learn and make predictions. The weight matrix may be decomposed into multiple matrices where the product of the multiple matrices will equal the weight matrix. In an aspect, the significant components of the multiple matrices are identified to form a first portion of matrix components, and the balance of matrix values form a second group of less significant components. In an aspect, the significant components may be recombined to form a significant matrix, while the less significant components are recombined into a less significant matrix. The significant matrix undergoes first level of quantization to form a significant quantized matrix. The less significant matrix undergoes a more significant quantization to form a less significant quantized matrix. The layer output is generated by combining the result produced by the significant matrix and the less significant matrix.

### BRIEF DESCRIPTION OF THE DRAWINGS

The technology described herein is illustrated by way of example and not limitation in the accompanying figures in which like reference numerals indicate similar elements and in which:

FIG. 1 is a diagram of a computing system suitable for implementations of the technology described herein;

FIG. 2 is a block diagram of an example operating environment for a quantized machine-learning model, in accordance with an aspect of the technology described herein;

FIG. 3 is a block diagram illustrating layer decomposition, in accordance with an aspect of the technology described herein;

FIG. 4 is a block diagram illustrating differential layer quantization, in accordance with an aspect of the technology described herein;

FIG. 5 is a flow diagram showing a method of generating a quantized neural network, in accordance with an aspect of the technology described herein;

FIG. 6 is a flow diagram showing a method of using a quantized neural network, in accordance with an aspect of the technology described herein;

FIG. 7 is a flow diagram showing a method of generating a quantized neural network, in accordance with an aspect of the technology described herein; and

FIG. 8 is a block diagram showing a computing device suitable for implementations of the technology described herein.

### DETAILED DESCRIPTION

The various technologies described herein are set forth with sufficient specificity to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

The technology described herein is related to a differentially quantized neural network that improves operational efficiency of the neural network without significant performance degradation. Differential quantization offers an efficiency advantage whether the neural network operates on an edge device or in the cloud. The efficiency gained might enable large neural networks, like language models (LMs) (e.g., LLM, small language model (SLM)), to run on edge devices that otherwise lacked the processing capacity, memory capacity, or memory throughput to run a LM. Differential quantization performs different levels of quantization on different portions of a neural network, including different portions of a single neural network layer. Differential quantization results in values in a single layer being stored at different levels of precision. For example, a first portion of values may be stored in a floating-point format (e.g., float16) while a second portion are stored in an integer format (e.g., Int8). The objective of the differential quantization method presented here is to minimize or eliminate quantization on the most critical parts of a neural network while applying higher degrees of quantization to the less critical sections of the network. In some instances, the significant and less significant parts of a neural network can be identified through a matrix decomposition process.

A given number can be represented using different precision (e.g., different quantized precision) formats or level. For example, a number can be represented in a higher precision format (e.g., float32) and a lower precision format (e.g., float16 or INT8). Lowering the precision of a number can include reducing the number of bits used to represent the mantissa or exponent of the number. Additionally, lowering the precision of a number can include reducing the range of values that can be used to represent an exponent of the number. Similarly, increasing the precision of a number can include increasing the number of bits used to represent the mantissa or exponent of the number. Additionally, increasing the precision of a number can include increasing the range of values that can be used to represent an exponent of the number. As used herein, converting a number from a higher precision format to a lower precision format may be referred to as down-casting or quantizing the number. Converting a number from a lower precision format to a higher precision format may be referred to as up-casting or de-quantizing the number.

A neural network layer includes a matrix of weights that plays a role in the network's ability to learn and make predictions. The weight matrix may be decomposed into multiple matrices where the product of the multiple matrices will equal the weight matrix. In an aspect, the significant components of the multiple matrices are identified to form a first portion of matrix values, and the balance of matrix values form a second group of less significant components. In an aspect, the significant components may be recombined to form a significant matrix, while the less significant components are recombined into a less significant matrix. The significant matrix undergoes first level of quantization to form a significant quantized matrix. The less significant matrix undergoes a more significant quantization to form a less significant quantized matrix. The layer output is generated by combining the result produced by the significant matrix and the less significant matrix. In aspects, instead of two matrices, three or more matrices may be generated and subjected to different levels of quantization with the least significant values receiving the most quantization and the most significant values the least quantization.

Neural network operations are used in many artificial intelligence operations. Often, the bulk of the processing operations performed in implementing a neural network is in performing Matrix×Matrix or Matrix×Vector multiplications or convolution operations. Such operations are compute- and memory-bandwidth intensive, where the size of a matrix may be, for example, 1000×1000 elements (e.g., 1000×1000 numbers, each including a sign, mantissa, and exponent) or larger and there are many matrices used. As discussed herein, differential quantization techniques can be applied to such operations to reduce the demands for computation as well as memory capacity & bandwidth in a given system, whether it is a Field-Programmable Gate Array (FPGA), central processing unit (CPU), graphics processing unit (GPU), neural processing unit (NPU), or another hardware platform.

The technology described herein may be applied after training the neural network or during training. When applied after training, the technology described herein decomposes a layer of a trained neural network's matrix(s) into two or more groups of matrix values. The two or more groups include a small group of significant matrix values and a large group of less significant matrix values. There may also be one or more intermediate groups. The small group is formed by identifying a small amount (relative to total values in the matrix) of matrix values that provide the largest contribution to an accurate model result. These are designated as significant components. The small number of significant components are designated to undergo the least significant quantization. The less significant components from the decomposed matrices receive more quantization than the significant components.

In aspects, some layers of a neural network may not undergo quantization, while portions of other layers undergo quantization. In addition, the number of matrix components in each layer that are quantized may vary from layer to layer. For example, in a first layer 990 values out of 1000 may be quantized, while 10 are not. In a second layer, 950 values of 1000 may be quantized, while 50 are not. It has been discovered that quantizing matrix values from different types of layers causes different results. For example, in several GPT models, quantizing matrix values from feedforward layers causes more performance decline than quantizing the same amount of matrix values from an attention layer. In this context, it may be desirable to quantize less matrix values from feedforward layers, while quantizing more values in attention layers.

As every model may be different and results may vary from architecture to architecture, testing the performance decline caused by quantizing matrix values from the model may be performed to select the amount of matrix values quantized from each layer. In aspects, a performance decline threshold can be specified, such as 1%, 5%, or 10%. A performance decline may be measured by model accuracy or some other measure, by comparing the result generated by the quantized model with a ground truth result produced with the same input to the original model.

Traditionally NNs have been trained and deployed using single-precision floating-point (32-bit floating-point or float32 format). Numbers represented in normal-precision floating-point format (e.g., a floating-point number expressed in a 16-bit floating-point format, a 32-bit floating-point format, a 64-bit floating-point format, or an 80-bit floating-point format) can be converted to quantized-precision format numbers that may allow for efficiency benefits. In particular, NN weights and activation values can be represented in a lower-precision quantized format with an acceptable level of error introduced. Examples of lower-precision quantized formats include formats having a reduced bit width (including by reducing the number of bits used to represent a number's mantissa or exponent). Operating some neural networks, such as large language models, is resource intensive. The resources used include processing capacity, computer memory, and electricity. Performing matrix operations on quantized values, rather than full values provides a significant efficiency gain.

The technologies herein are described using key terms wherein definitions are provided. However, the definitions of key terms are not intended to limit the scope of the technologies described herein.

In one example, a neural network is a computational model that consists of layers of nodes, or “neurons,” each receiving input, processing it, and passing the output to the next layer. Neural networks can include distinct types of layers. Example layer types include convolutional, activation, pooling, fully connected, batch normalization, dropout, recurrent layers, feedforward layers, embedding layers, and attention layers.

In one example, a “language model” is a set of statistical or probabilistic functions that performs Natural Language Processing (NLP) to understand, learn, and/or generate human natural language content. A language model is one example of a neural network. For example, a language model can be a tool that determines the probability of a given sequence of words occurring in a sentence (e.g., via NSP or MLM) or natural language sequence. Simply put, it can be a tool which is trained to predict the next word in a sentence. A language model is called a large language model (“LLM”) when it is trained on enormous amount of data. Some examples of LLMs are GOOGLE's BERT and OpenAI's GPT-2 and GPT-3. GPT-3, and GPT-4, which has over 175 billion parameters trained on over 570 gigabytes of text. Additional LLM models include GPT-4o, Llama 3, Mistral, Gemini, and DeepSeek. A small language model may be trained on less data. These models have capabilities ranging from drafting an essay to generating complex computer codes—all with limited to no supervision. Accordingly, an LLM is a deep neural network that is very large (billions to hundreds to trillions of parameters) and understands, processes, and produces human natural language by being trained on massive amounts of text. These models can predict future words in a sentence letting them generate sentences like how humans talk and write. In some embodiments, the LLM is pre-trained (e.g., via NSP and MLM on a natural language corpus to learn English) without having been fine-tuned but rather uses prompt engineering/prompting/prompt learning using one-shot or few-shot examples.

A language model may perform various tasks, such as machine translation, natural language summary, question answering, and sentiment analysis. A “natural language summary” as described herein refers to text summarization. Text summarization (or automatic summarization or NLP text summarization) is the process of breaking down text (e.g., several paragraphs) into smaller text (e.g., one sentence or paragraph). In other words, text summarization is the process of distilling the most important information from a source (or sources) to produce an abridged version for a particular user (or users) and task (or tasks). This method extracts vital information while also preserving the meaning of the text. This reduces the time required for grasping lengthy pieces such as articles without losing vital information, for example. For example, using extraction summarization, some embodiments, using NLP, detect key chunks of natural language text, extracting or cutting them out, then stitching them back together to create a shortened form of the dataset. For instance, a sentence in the dataset may read, “I'm heading to the supermarket by taking Ray Road. there will not be as much traffic at that time. I'm going to buy fruit.” Extraction summarization may work by reducing the characters to “I'm heading to the supermarket. I'm going to buy fruit.” In another example, abstractive summarization works by generating new sentences (or other natural language characters) from the original dataset. For example, using the original dataset described above, the summarization may be, “I'm heading to the store to buy fruit,” where “store” is a new word input into the new sentence (e.g., based on NLP semantic analysis and/or Named Entity Recognition NER and “I'm going” is removed from the original sentence. NER is an information extraction technique that identifies and classifies tokens/words or “entities” in natural language text into predefined categories. Such predefined categories may be indicated in corresponding tags or labels, which can be used in summaries. Entities can be, for example, names of people, specific organizations, specific locations, specific times, specific quantities, specific monetary price values, specific percentages, specific pages, and the like.

In an example, a precision level refers to the level of detail in which the quantity is expressed. Precision is typically measured in bits, which determine the number of significant digits that can be represented. Higher precision allows for more accurate representation of values, reducing rounding errors and improving the reliability of computations. Different number formats have different precision levels.

Different number formats use different bytes. Integers represent whole numbers. Common integer formats include 8-bit integer, 16-bit integer, 32-bit integer, and 64-bit integer. 8-bit integer uses 1 byte, representing values from −128 to 127 (signed) or 0 to 255 (unsigned). 16-bit integer uses 2 bytes, representing values from −32,768 to 32,767 (signed) or 0 to 65,535 (unsigned). 32-bit integer uses 4 bytes, representing values from −2,147,483,648 to 2,147,483,647 (signed) or 0 to 4,294,967,295 (unsigned). 64-bit integer uses 8 bytes, representing values from −9,223,372,036,854,775,808 to 9,223,372,036,854,775,807 (signed) or 0 to 18,446,744,073,709,551,615 (unsigned). Floating-point numbers represent real numbers with a fractional component. Common floating-point formats include half precision, single precision (32-bit), double precision, and quadruple precision. Half precision uses 2 bytes, with 1 bit for the sign, 5 bits for the exponent, and 10 bits for the mantissa. Single precision uses 4 bytes, with 1 bit for the sign, 8 bits for the exponent, and 23 bits for the mantissa. Double precision (64-bit) uses 8 bytes, with 1 bit for the sign, 11 bits for the exponent, and 52 bits for the mantissa. Other formats include Bfloat16 (Brain Floating Point), FP8 (8-bit Floating Point), and MSFP (Microsoft Floating Point).

A standard floating-point representation in a computer system comprises three components: the sign (s), exponent (e), and mantissa (m). The sign denotes whether the number is positive or negative. The exponent and mantissa function similarly to scientific notation: Value=s×m×2^{e}.

Within the precision limits of the mantissa, any number may be represented. The exponent scales the mantissa by powers of 2, analogous to scaling by powers of 10 in scientific notation, allowing the representation of extremely large magnitudes. The precision is determined by the mantissa's accuracy. Common floating-point representations utilize mantissas that are 10 (float 16), 24 (float 32), or 53 (float 64) bits wide. An integer with a magnitude exceeding 2\hat{ }53 can be approximated in a float 64 format but will not be exact due to insufficient mantissa bits. Similarly, arbitrary fractions might be imprecise because the mantissa represents fraction bits as negative powers of 2. Many fractions cannot be exactly represented due to their irrationality in a binary system. More precise representations are feasible but necessitate additional mantissa bits. Ultimately, an infinite number of mantissa bits are required for exact representation of some numbers (e.g., ⅓=0.3; 22/7=3.142857). The use of 10-bit (half precision float), 24-bit (single precision float), and 53-bit (double precision float) mantissa limits are common compromises between storage requirements and representation precision in general-purpose computers.

In an example, as used herein the term “tensor” refers to a multi-dimensional array that can be used to represent properties of a NN and includes one-dimensional vectors as well as two-, three-, four-, or larger dimension matrices. As used in this disclosure, tensors do not require any other mathematical properties unless specifically stated.

In an example, as used herein the term “normal-precision floating-point” refers to a floating-point number format having a mantissa, exponent, and optionally a sign and which is natively supported by a native or virtual CPU. Examples of normal-precision floating-point formats include, but are not limited to, IEEE 754 standard formats such as 16-bit, 32-bit, 64-bit, 128-bit, or 256-bit supported by a processor, such as Intel AVX, AVX2, IA32, x86_64, or 80-bit floating-point formats.

Having briefly described an overview of aspects of the technology described herein, an operating environment in which aspects of the technology described herein may be implemented is described below in order to provide a general context for various aspects.

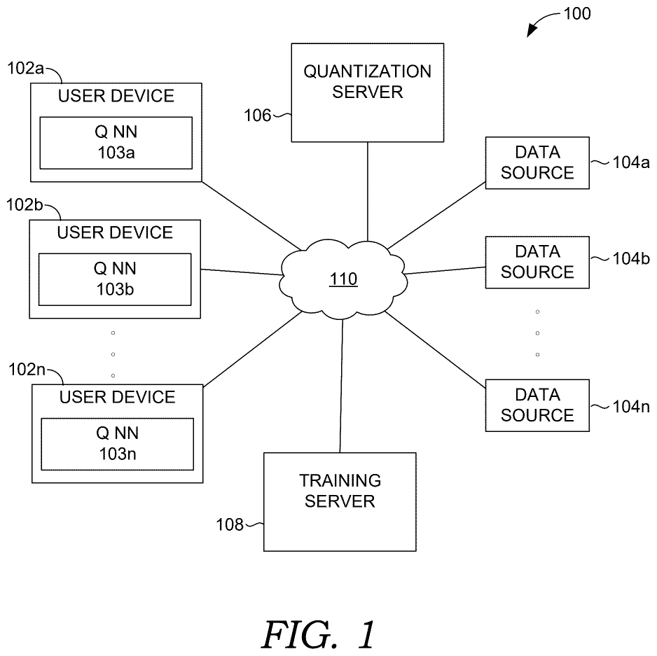

Turning now to FIG. 1, a block diagram is provided showing an example operating environment 100 in which some embodiments of the present disclosure can be employed. This and other arrangements described herein are set forth only as examples. Other arrangements and elements (for example, machines, interfaces, functions, orders, and groupings of functions) can be used in addition to or instead of those shown, and some elements can be omitted altogether for the sake of clarity. Further, many of the elements described herein are functional entities that are implemented as discrete or distributed components or in conjunction with other components, and in any suitable combination and location. Various functions described herein as being performed by one or more entities are carried out by hardware, firmware, and/or software. For instance, some functions are carried out by a processor executing instructions stored in memory.

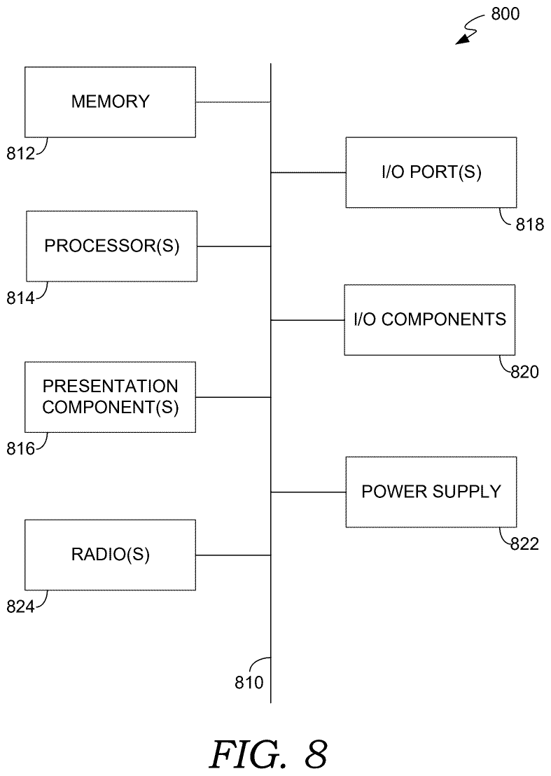

Among other components not shown, example operating environment 100 includes several user computing devices, such as user devices 102a through 102n; several data sources, such as data sources 104a and 104b through 104n; quantization server 106; training server 108; and network 110. Each of the components shown in FIG. 1 is implemented via any type of computing device, such as computing device 800 illustrated in FIG. 8. In one embodiment, these components communicate with each other via network 110, which includes, without limitation, one or more local area networks (LANs) and/or wide area networks (WANs). In one example, network 110 comprises the internet, intranet, and/or a cellular network, amongst any of a variety of possible public and/or private networks.

Any number of user devices, servers, and data sources can be employed within operating environment 100 within the scope of the present disclosure. Each may comprise a single device or multiple devices cooperating in a distributed environment. For instance, quantization server 106 is provided via multiple devices arranged in a distributed environment that collectively provides the functionality described herein. Additionally, other components not shown may also be included within the distributed environment.

User devices 102a, 102b, through 102n can be client user devices on the client-side of operating environment 100, while quantization server 106 and training server 108 can be on the server-side of operating environment 100. The user devices may be described as client devices and/or edge devices herein. Quantization server 106 can comprise server-side software designed to work in conjunction with client-side software on user devices 102a through 102n to implement any combination of the features and functionalities discussed in the present disclosure. In one aspect, the quantization server 106 produces the quantized neural networks 103a through 103n. The quantized neural networks 103a, 103b, through 103n.

In aspects, the user devices 102a through 102n provide a user interface to the quantized neural network environment 200. The user interface may facilitate reception of user input, such as a natural language prompt, query, and/or image. The user interface may also provide a final output generated by the quantized neural networks. The interfaces may be generated in combination with functions provided by quantized neural networks 103a, 103b, through 103n. This division of operating environment 100 is provided to illustrate one example of a suitable environment, and there is no requirement for each implementation that any combination of the quantization server 106, training server 108 and user devices and 102a through 102n remain as separate entities.

In some embodiments, user devices 102a through 102n comprise any type of computing device capable of use by a user. For example, in one embodiment, user devices 102a through 102n are the type of computing device 800 described in relation to FIG. 8. By way of example and not limitation, a user device is embodied as a personal computer (PC), a laptop computer, a mobile device, a smartphone, a tablet computer, a virtual-reality (VR) or augmented-reality (AR) device or headset, a handheld communication device, an embedded system controller, a consumer electronic device, a workstation, any other suitable computer device, or any combination of these delineated devices.

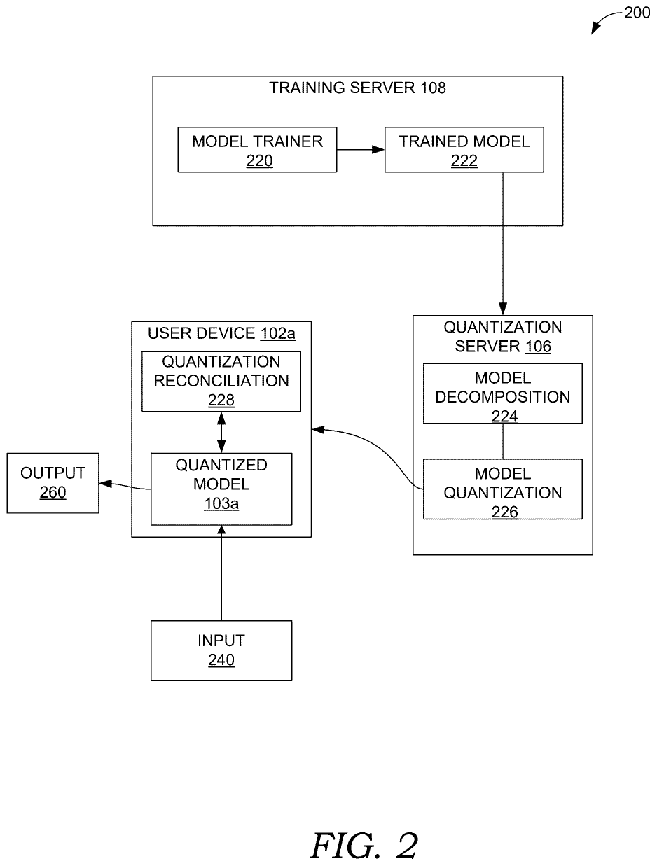

In some embodiments, data sources 104a and 104b through 104n comprise data sources and/or data systems, which are configured to make data available to any of the various constituents of operating environment 100 or environment 200 described in connection to FIG. 2. The data sources may include training data for the training server 108 and/or input and output from a trained model. The training server 108 may train a neural network, such as an LLM, before it is deployed to a client device. Certain data sources 104a and 104b through 104n are discrete from user devices 102a through 102n and the quantization server 106 and training server 108 or are incorporated and/or integrated into at least one of those components. In one embodiment, one or more of data sources 104a and 104b through 104n comprise one or more sensors, which are integrated into or associated with one or more of the user device(s) 102a through 102n or quantization server 106. For example, the data sources could include a web camera used to interact with a virtual environment. The quantization server 106 can provide services related to identifying significant matrix components and differential quantization.

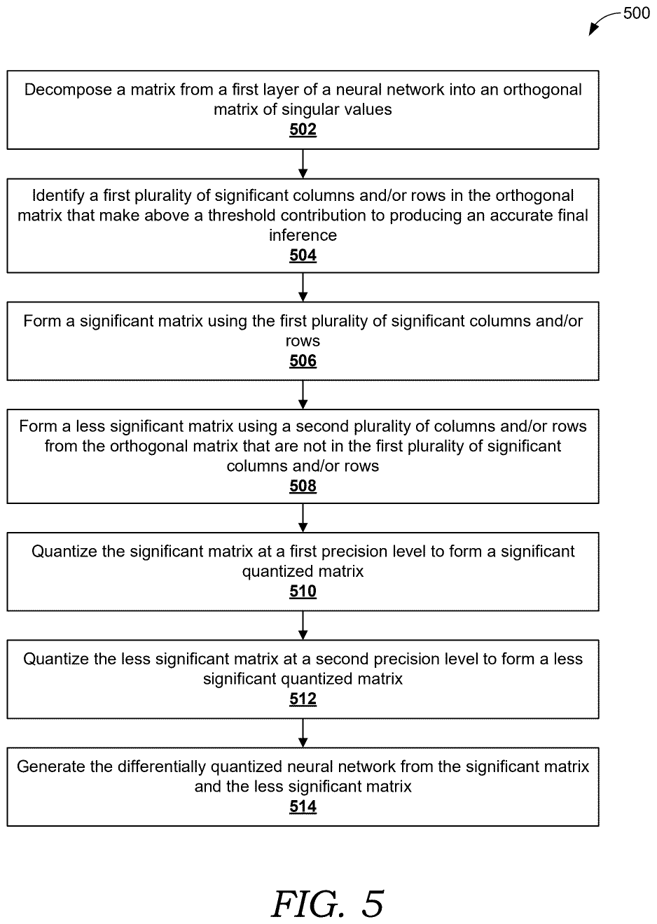

Operating environment 100 can be utilized to implement one or more of the components of environment 200, as described in FIG. 2. Operating environment 100 can also be utilized for implementing aspects of methods 500, 600, and 700 in FIGS. 5, 6, and 7, respectively.

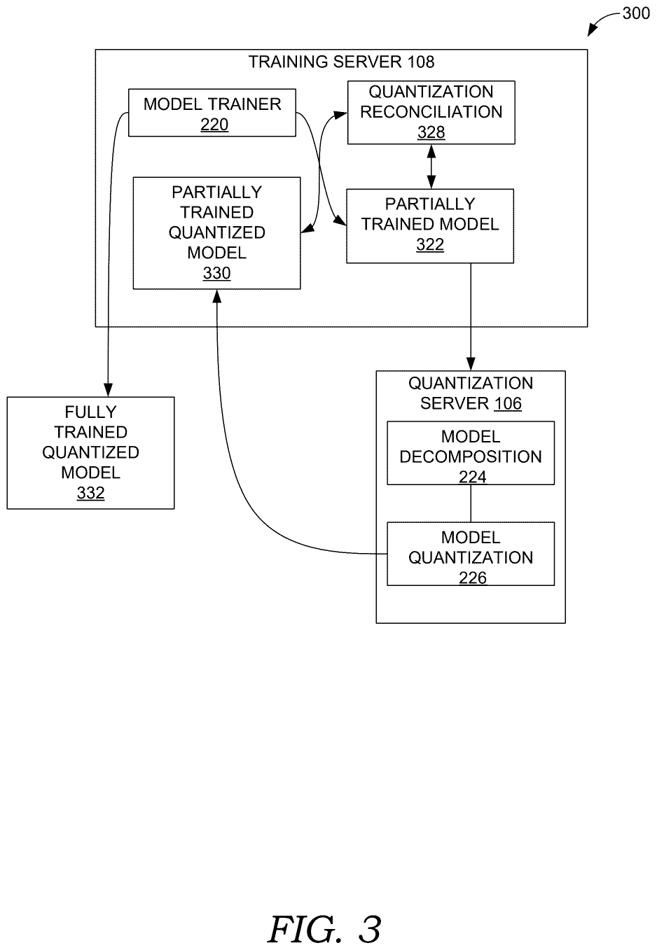

Referring now to FIG. 2 with FIG. 1, a block diagram is provided showing aspects of an example quantized network environment suitable for implementing some embodiments of the disclosure and designated generally as environment 200. The environment 200 illustrates an embodiment where a fully trained model is used to form a quantized model 103a. In contrast, FIG. 3 illustrates an embodiment where the model is quantized during training to produce the quantized model 103a. The environment 200 includes the training server 108, the user device 102a, and the quantization server 106. The quantized neural network 103a may generate an output 260 in response to input 240.

The environment 200 represents only one example of a suitable computing system architecture. Other arrangements and elements can be used in addition to or instead of those shown, and some elements may be omitted altogether for the sake of clarity. Further, as with operating environment 100, many of the elements described herein are functional entities that may be implemented as discrete or distributed components or in conjunction with other components, and in any suitable combination and location. These components may be embodied as a set of compiled computer instructions or functions, program modules, computer software services, or an arrangement of processes carried out on one or more computer systems.

In one embodiment, the functions performed by components of environment 200 are associated with training and using a ML model. These components, functions performed by these components, and/or services carried out by these components may be implemented at appropriate abstraction layer(s) such as the operating system layer, application layer, and/or hardware layer of the computing system(s). Alternatively, or in addition, the functionality of these components, and/or the embodiments described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs). Additionally, although functionality is described herein with regards to specific components shown in example environment 200, it is contemplated that in some embodiments functionality of these components can be shared or distributed across other components and/or computer systems.

By way of overview, the training server 108 includes a model trainer 220 that generates a trained model 222. The significant components of the trained model 222 that are to be quantized at a first level and the least significant components that are to be quantized at a second level are first identified by the model decomposition component 224. Once decomposition occurs and the most and least significant components are identified, a quantized neural network 103a is constructed by the model quantization component 224. The quantized neural network 103a may be differentially quantized within a layer and between layers. This means that a first partial layer with the most significant components may receive a first level of quantization while the other portion of the first layer receives a second level of quantization. Similarly, different quantization levels may be applied to different layers. Once deployed, the quantized neural network 103a may process an input 240 to generate an output 260.

The model trainer 220 of the training server 108 generates a trained model 222. For the sake of illustration, the model trainer 220 may train a Large Language Model (e.g., a BERT model or GPT-4 model) that uses inputs to make predictions (e.g., generate answers), according to some embodiments. In some embodiments, the LLM represents or includes the functionality as described with respect to the trained model 222 that is used to generate the quantized model 103a.

As a preliminary training step, the model trainer 220 may generate training data by converting a natural language corpus (e.g., various WIKIPEDIA English words or BooksCorpus) into tokens and feature vectors, which are formed into an input embedding that encode meaning of individual natural language words (for example, English semantics). In some embodiments, to understand English language, corpus documents, such as textbooks, periodicals, blogs, social media feeds, and the like are ingested by the language model.

In some embodiments, each word or character in the input(s) is mapped into the input embedding in parallel or at the same time, unlike existing long short-term memory (LSTM) models, for example. The input embedding maps a word to a feature vector representing the word. But the same word (for example, “apple”) in different sentences may have different meanings (for example, phone v. fruit). This is why a positional encoder can be implemented. A positional encoder is a vector that gives context to words (for example, “apple”) based on a position of a word in a sentence. For example, with respect to a message “I just sent the document,” because “I” is at the beginning of a sentence, embodiments can indicate a position in an embedding closer to “just,” as opposed to “document.” Some embodiments use a sign/cosine function to generate the positional encoder vector as follows:

$$\text{?} PE \text{?} \_ ( ( pos , 2 i ) ) = sin \text{?} ( pos / \text{?} 10000 \text{?} \hat{} ( \text{?} 2 i / d \text{?} \_model ) - \vert )$$

$$\text{?} PE \text{?} \_ ( ( pos , 2 i + 1 ) ) = cos \text{?} ( pos / \text{?} 10000 \text{?} \hat{} ( \text{?} 2 i / d \text{?} \_model ) ) - \vert$$

After passing the input(s) through the input embedding and applying the positional encoder, the output is a word embedding feature vector, which encodes positional information or context based on the positional encoder. These word embedding feature vectors are then passed to the encoder and/or decoder block(s), where it goes through a multi-head attention layer and a feedforward layer.

The multi-head attention layer is generally responsible for focusing or processing certain parts of the feature vectors representing specific portions of the input(s) by generating attention vectors. For example, in Question Answering systems, the multi-head attention layer determines how relevant the ith word (or particular word in a sentence) is for answering the question or relevant to other words in the same or other blocks, the output of which is an attention vector. For every word, some embodiments generate an attention vector, which captures contextual relationships between other words in the same sentence or other sequence of characters. For a given word, some embodiments compute a weighted average or otherwise aggregate attention vectors of other words that contain the given word (for example, other words in the same line or block) to compute a final attention vector.

In some embodiments, a single headed attention has abstract vectors Q, K, and V that extract different components of a particular word. These are used to compute the attention vectors for every word, using the following formula:

$$Z = softmax ( \text{?} Q \cdot K \text{?} \hat{} T / √ ( Dimension of vector Q , K or V ) ) \cdot V$$

For multi-headed attention, there a multiple weight matrices Wq, Wk, and Wv, so there are multiple attention vectors Z for every word. However, a neural network may only expect one attention vector per word. Accordingly, another weighted matrix, Wz, is used to make sure the output is still an attention vector per word. In some embodiments, after the layers and, there is some form of normalization (for example, batch normalization and/or layer normalization) performed to smoothen out the loss surface making it easier to optimize while using larger learning rates.

The LLM may include residual connection and/or normalization layers where normalization re-centers and re-scales or normalizes the data across the feature dimensions. The feedforward layer is a feed forward neural network that is applied to every one of the attention vectors outputted by the multi-head attention layer. The feedforward layer transforms the attention vectors into a form that can be processed by the next encoder block or making a prediction. For example, given that a document includes first natural language sequence “the due date is . . . ” the encoder/decoder block(s) predicts that the next natural language sequence will be a specific date or particular words based on past documents that include language identical or similar to the first natural language sequence.

In some embodiments, the initial embedding (for example, the input embedding) is constructed from three vectors: the token embeddings, the segment or context-question embeddings, and the position embeddings. In some embodiments, the following functionality occurs in the pre-training phase. The token embeddings are the pre-trained embeddings. The segment embeddings are the sentence number (that includes the input(s)) that is encoded into a vector (for example, first sentence, second sentence, etc. assuming a top-down and right-to-left approach). The position embeddings are vectors that represent the position of a particular word in such sentence that can be produced by positional encoder. When these three embeddings are added or concatenated together, an embedding vector is generated that is used as input into the encoder/decoder block(s). The segment and position embeddings are used for temporal ordering since all the vectors are fed into the encoder/decoder block(s) simultaneously and language models need some sort of order preserved.

In some embodiments, once pre-training is performed, the encoder/decoder block(s) performs prompt engineering (fine-tuning or prompt-tuning) and/or zero-shot learning on a variety of QA (e.g., prompt and output) data sets by converting different QA formats into a unified sequence-to-sequence format. For example, some embodiments perform the QA task by adding a new question-answering head or encoder/decoder block, just the way a masked language model head is added (in pre-training) for performing a MLM task, except that the task is a part of prompt engineering, zero-shot learning, prompt-tuning, and/or fine-tuning. This includes the encoder/decoder block(s) processing the inputs (i.e., the target datasets and the prompt instructions) to make the predictions and confidence scores. Prompt engineering, in some embodiments, is the process of crafting and optimizing text prompts for language models to achieve desired outputs. In other words, prompt engineering is the process of mapping prompts (e.g., an instruction/question) to the output (e.g., an answer) that it belongs to for training. For example, if a user asks a model to generate a poem about a person fishing on a lake, the expectation is it will generate a different poem each time. Users may then label the output or answers from best to worst. Such labels are an input to the model to make sure the model is giving a more human-like or best answers, while trying to minimize the worst answers (e.g., via reinforcement learning). In some embodiments, a “prompt” as described herein includes one or more of a request (e.g., a question or instruction (e.g., write a summary of a poem)), one or more datasets, a command or instruction, code snippets, mathematical equations, and/or one or more examples (e.g., one-shot or two-shot examples). The “prompt instructions” as included in the inputs can include any of the instructions as described herein. Once trained through the above method, different method, or variation, the trained model 222 is saved and then decomposed by the decomposition component 224.

The decomposition component 224 may use matrix decomposition to identify the matrix components in a layer that provide the largest contribution to the network generating an accurate answer. The matrix components that make the largest contribution are described herein as the significant components. Matrix components that are not identified as significant may be described as less significant components. The less significant components may be further broken into separate significance groups. In a neural network, matrices may be used to represent the weights and biases of the nodes (also known as neurons). Potential matrices in a neural network include weight matrices, bias matrices, and activation function matrices. Weight matrices are used to do weight calculations for a layer. Weights are learned during training. Each connection between nodes in adjacent layers of a neural network has an associated weight. If there is a fully connected layer with n nodes and the next layer has m nodes, then all the weights between these two layers may be represented as an n×m matrix. Each entry in the matrix corresponds to a weight of a connection between two nodes (a node in the current layer and a node in the previous layer). In one aspect, a column of the weight matrix will correspond to the weights of a single node, which may include a different weight for each input connection to the node. Each node in a layer (except for the input layer) may have an associated bias. If a layer has n nodes, the biases for that layer can be represented as an n×1 matrix (a column vector). The activations of the nodes (i.e., their outputs) can also be represented as matrices. If a layer has n nodes, the activations can be represented as an n×1 matrix.

When a neural network is processing input or learning from errors (during backpropagation), it performs matrix operations (like multiplication and addition) on these matrices. For example, to calculate the inputs to a layer of nodes, the network multiplies the activation matrix of the previous layer by the weight matrix of the current layer and then adds the bias matrix for the current layer. This result may then be passed through a non-linear function (like ReLU or sigmoid) to get the activation matrix for the current layer.

Matrix decomposition may be used to identify the matrix components that provide the largest contribution to generating a high-quality response to an input. These matrix components are the significant components. Matrix decomposition, also known as matrix factorization, involves breaking down a matrix into a product of matrices. In aspects, Singular Value Decomposition (SVD) is used for decomposition. SVD is a generalization of the singular value decomposition to non-square matrices. Other matrix decomposition methods may be used. Preferred decomposition methods may be described as Rank-Revealing Factorization methods and may include SVD, QR factorization with column pivoting, QR Factorization with Other Pivoting Choices, UTV Decomposition, and LU Factorization.

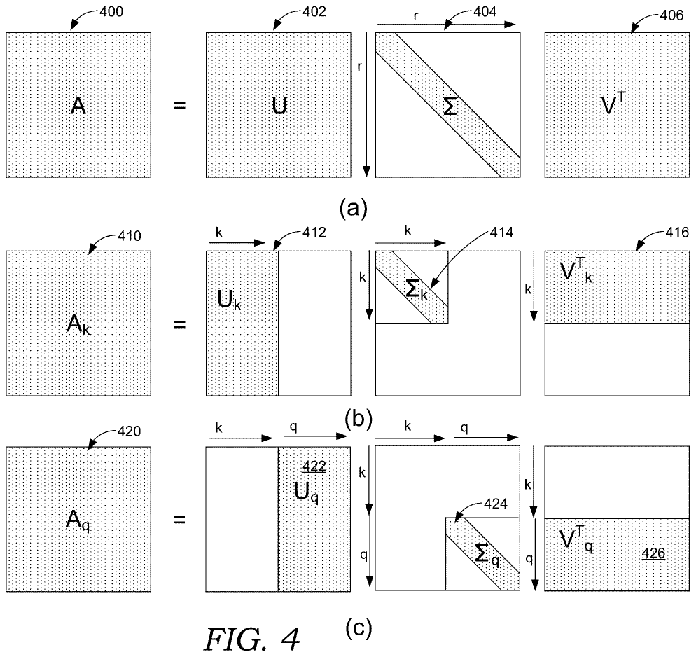

The decomposition component 224 may use SVD, as illustrated in FIG. 4. As shown in row (a), SVD decomposes a matrix A 400 into a product of three matrices: an orthogonal matrix (U) 402, a diagonal matrix of singular values (Σ) 404, and the transpose of an orthogonal matrix (V^{T}) 406. Matrix A 400 could be a weight matrix of a NN or some other matrix. If the matrix being decomposed is A, then A=UΣV^{T}. The columns of the orthogonal matrix (U) 402 in Singular Value Decomposition (SVD) are the left singular vectors of the original matrix 400. The order of the columns in (U) 402 is significant because it corresponds to the order of the singular values in the Σ matrix 404.

The first column of the orthogonal matrix (U) 402 corresponds to the largest singular value in Σ, the second column corresponds to the second largest singular value, and so on. This means that the columns of U are ordered by the amount of variance in the original data that they account for. The first column of (U) 402 is the direction in the data space along which the data varies the most. In the context of Principal Component Analysis (PCA), the columns of the orthogonal matrix (U) 402 (the left singular vectors) are the principal components of the data, and the order of the columns indicates the importance of the corresponding principal component. The first few columns (principal components) typically capture most of the variation in the data. The remaining columns (principal components) capture less and less of the data's variation.

Once decomposed, a threshold number of columns from the orthogonal matrix (U) 402 may be selected for a first level of quantization. This threshold amount is represented by k in the second row (b) of matrices shown in FIG. 4. The number of matrix components k in each layer that are designated for the processor environment may vary from layer to layer. As shown, k is larger than might be the case in actual implementations. For example, in a first layer 5 matrix components out of 1000 may be designated as significant components and designated for a first level of quantization. In a second layer, 10 matrix components of 1000 may be designated as significant components and designated for a first level of quantization. It has been discovered that removing matrix components from different types of layers causes different results. For example, in several GPT models, quantizing matrix components from feedforward layers causes more degradation than quantizing the same amount of matrix components from an attention layer. In this context, it may be desirable to quantizing matrix more components from attention layers and less from feedforward layers. In other words, k may be a larger number in attention layers compared to feedforward layers.

As every model may be different and results may vary from architecture to architecture, testing the degradation caused by quantizing matrix components from the model may be performed to select the amount of matrix components k quantized from the matrices of each layer. The testing can also inform the level of quantization chosen. In aspects, a desired degradation target can be specified, such as less than 1%, 2%, or 5% degradation. Degradation may be measured by model accuracy, by comparing the result generated by the degraded model with a ground truth result associated with the input.

There are several metrics used to measure the accuracy of a language model or a neural network. Example metrics include accuracy, precision, recall, F1 Score, Mean Squared Error (MSE), Root Mean Squared Error (RMSE), and Area Under ROC Curve (AUC-ROC). Accuracy is a ratio of correctly predicted observation to the total observations. Precision is the ratio of correctly predicted positive observations to the total predicted positive observations. It's also called Positive Predictive Value (PPV). It is a measure of a classifier's exactness. Low precision indicates a high number of false positives. Recall is the ratio of correctly predicted positive observations to all observations in actual class. Recall may also be called Sensitivity, Hit Rate, or True Positive Rate. Recall is a measure of a classifier's completeness. Low recall indicates a high number of false negatives. F1 Score is the weighted average of Precision and Recall. Therefore, this score takes both false positives and false negatives into account. MSE is the average of the squared difference between the predicted and actual values. RMSE is the square root of MSE. A ROC Curve is a plot of true positive rate against false positive rate. It shows the tradeoff between sensitivity and specificity (any increase in sensitivity will be accompanied by a decrease in specificity). The closer the curve follows the left-hand border and then the top border of the ROC space, the more accurate the test. The closer the curve comes to the 45-degree diagonal of the ROC space, the less accurate the test. The area under the curve is a measure of test accuracy. Each of these metrics has its own strengths and weaknesses, and they give different insights about the performance of the model.

In aspects, an orthogonal matrix (Uₖ) 412, a diagonal matrix of singular values (Σₖ) 414, and the transpose of an orthogonal matrix (V^{T}ₖ) 416 are multiplied to form matrix Aₖ 410. Matrix Aₖ 410 may then be quantized at a first level. Matrix Aₖ 410 may be referred to as a significant quantized matrix.

The data from the matrices not included in the k matrices may form a second set of matrices, as shown in row (c). The matrices in row (c) are defined by q, which is r-k. In aspects, the set of matrices are recombined into a single matrix A_{q} 420 and quantized to a second level that is less precise than the first level. The matrix A_{q} 420 may be described as a less significant quantized matrix.

The model quantization component 226 performs decomposition on the significant quantized matrix and the less significant quantized matrix. The model quantization component 226 may use different quantization methods. In one example, symmetric quantization is used. In symmetric quantization, the range of the original floating-point values is mapped to a symmetric range around zero in the quantized space. Symmetric quantization starts by identifying the range of values in the dataset or model parameters that need to be quantized. For symmetric quantization, this range is typically centered around zero and is denoted as [−a, a]. Next, the scale factor is calculated. The scale factor (ss) is used to map the floating-point values to integer values. It is calculated based on the maximum absolute value in the range:

$$s = \frac{a}{127}$$

Here, 127 is the maximum value that can be represented in an 8-bit signed integer format, as one possible example output precision. Once the scale factor is determined, the floating-point values are converted to integer values using the scale factor. The quantized value (q) is obtained by q=round x/s where x is the original floating-point value. Finally, the quantized value, which are now in the range [−127,127] are stored and used to build the quantized matrix where each original value x is replaced with its q. The model quantization component 226 may also dequantize. To convert the quantized integer values back to floating-point values the inverse of the scale factor may be used x=q×s.

In another aspect, model quantization component 226 may use asymmetric quantization. The first step in asymmetric quantization is to identify the range of values in the dataset or model parameters that need to be quantized. Unlike symmetric quantization, the range is not required to be centered around zero. Let aₘᵢₙ and aₘₐₓ represent the minimum and maximum values in the range, respectively. The scale factor (s) is calculated based on the range of values. It is defined as:

$$s = \frac{a max - a min}{255}$$

Here, 255 is the maximum value that can be represented in an 8-bit unsigned integer format, as one possible example output precision. Each floating-point value x within the range aₘᵢₙ, aₘₐₓ is quantized to an integer value q using the scale factor. The quantized value is obtained by

$$q = round \frac{x - a min}{s} .$$

This maps the original values to the range [0,255].

As part of the quantization process, the model quantization component 226 may perform range clipping as part of range mapping. Range clipping eliminates outlier values in the range. Clipping involves setting a different dynamic range for the original values such that all outliers get the same value. For example, if the actual range was −9 to 30, but 98% of the values fall between −7 and 7 then the range could be set to −7 to 7. Any values falling outside of the range would be set to −7 or 7. The range could be selected manually. However, a calibration technique such as optimizing the mean squared error (MSE) between the original and quantized weights may be used. An alternative calibration technique is minimizing entropy (KL-divergence) between the original and quantized values.

Once the quantization is completed, the various quantized matrices may be combined and used to form the quantized model 103a. In operation, while quantized values in the weight matrices may remain at a fixed precision, intermediate values generated during inference may be quantized and/or de-quantized by the quantization reconciliation component 228. For example, an activation vector may be the result produced by a first layer of the quantized model 103a. The activation vector may be the result of matrix operations performed at different precision levels. For example, the activation vector may comprise the result of first operations performed with a significant quantized matrix with a first precision level and second operations performed with a less significant quantized matrix with a second precision level. This will result in an activation vector having values in two different precision levels. The quantization reconciliation component 228 may generate two activation vectors for use in the subsequent level. A high precision activation vector will have all values at the first, higher, precision level. Generating the high precision activation vector may involve dequantizing the lower precision values, while leaving the high precision values as-is. The high precision activation vector may be provided as input to the significant quantized matrix in the subsequent level. A low precision activation vector will have all values at the second, lower, precision level. Generating the low precision activation vector may involve quantizing the high precision values, while leaving the low precision values as-is. The low precision activation vector may be provided as input to the less significant quantized matrix in the subsequent level. This process may be repeated for each neural network layer in the quantized model 103a.

Turing now to FIG. 3, with FIGS. 1 and 2, a block diagram is provided showing aspects of an example computing environment 300 suitable for implementing some embodiments of the disclosure. The computing environment 300 illustrates the quantization of a neural network during the training process. The environment 300 includes the training server 108, the user device 102a, and the quantization server 106. The quantized neural network 103a may generate an output 260 in response to input 240.

Initially, the model trainer 220 may generate a partially trained model 322. The partially trained model 322 may undergo some training, but the training has not yet reached a convergence or other stopping point. The partially trained model 322 may undergo decomposition within the model decomposition component 224 to identify significant components and insignificant components. As described above, the model quantization 226 may quantize the partially trained model 322 to form the partially trained quantized model 330. The model trainer may then begin training the partially trained model 330 until the fully trained quantized model 332 is formed. During back propagation, the quantized values of the partially trained quantized model 330 may be updated while maintaining the quantized precision. The quantization reconciliation component 328 performs quantization and dequantization. The fully trained quantized model 332 may then be deployed as the quantized model 103a.

### Example Methods

Now referring to FIGS. 5, 6 and 7, each block of methods 500, 600, and 700, described herein, comprises a computing process that may be performed using any combination of hardware, firmware, and/or software. For instance, various functions may be carried out by a processor executing instructions stored in memory. The methods may also be embodied as computer-usable instructions stored on computer storage media. The method may be provided by an operating system. In addition, methods 500, 600, and 700 are described, by way of example, with respect to FIGS. 1-4. However, these methods may additionally or alternatively be executed by any one system, or any combination of systems, including, but not limited to, those described herein.

FIG. 5 is a flow diagram showing a method 500 of generating a differentially quantized neural network, in accordance with some embodiments of the present disclosure. Method 500 may be performed on or with systems similar to those described with reference to FIGS. 1-4.

As shown in FIG. 5, process 500 may include decomposing a matrix from a first layer of a neural network into an orthogonal matrix of singular values (block 502). As also shown in FIG. 5, process 500 may include identifying a first plurality of significant columns and/or rows in the orthogonal matrix that make above a threshold contribution to producing an accurate final inference (block 504). As further shown in FIG. 5, process 500 may include forming a significant matrix using the first plurality of significant columns and/or rows (block 506). As also shown in FIG. 5, process 500 may include forming a less significant matrix using a second plurality of columns and/or rows from the orthogonal matrix that are not in the first plurality of significant columns and/or rows (block 508). As further shown in FIG. 5, process 500 may include quantizing the significant matrix at a first precision level to form a significant quantized matrix (block 510). As also shown in FIG. 5, process 500 may include quantizing the less significant matrix at a second precision level to form a less significant quantized matrix (block 512). As further shown in FIG. 5, process 500 may include generating the differentially quantized neural network from the significant matrix and the less significant matrix (block 514).

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

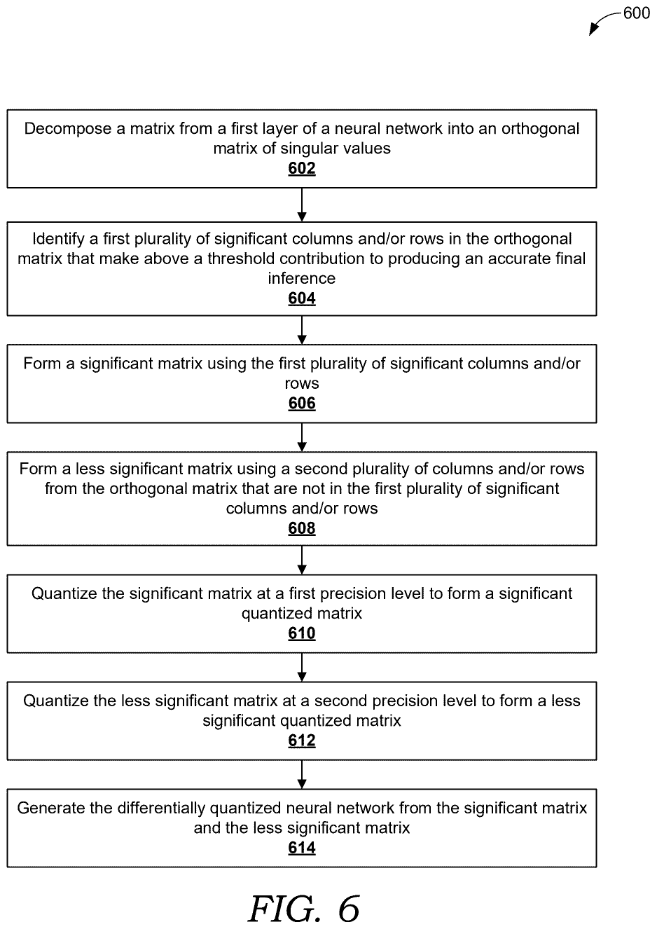

FIG. 6 is a flow diagram showing a method 600 of operating a differentially quantized neural network, in accordance with some embodiments of the present disclosure. Method 600 may be performed on or with systems similar to those described with reference to FIGS. 1-4.

As shown in FIG. 6, process 600 may include receiving, at a first layer of the differentially quantized neural network, an input (block 602). As also shown in FIG. 6, process 600 may include performing, at the first layer, a first plurality of matrix operations using a significant quantized matrix and the input at a first precision level to produce a first result (block 604). The matrix operation can include multiplying the input, which may be the activation vector from a previous layer, and the significant quantized matrix. The significant quantized matrix may take the place of a weight matrix. As further shown in FIG. 6, process 600 may include performing, at the first layer, a second plurality of matrix operations using a less significant quantized matrix and the input at a second precision level to produce a second result. The matrix operation can include multiplying the input, which may be the activation vector from a previous layer, and the less significant quantized matrix. The less significant quantized matrix may take the place of a weight matrix. The second precision level is lower than the first precision level (block 606). As also shown in FIG. 6, process 600 may include combining the first result and the second result to produce an output for the first layer (block 608).

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel.

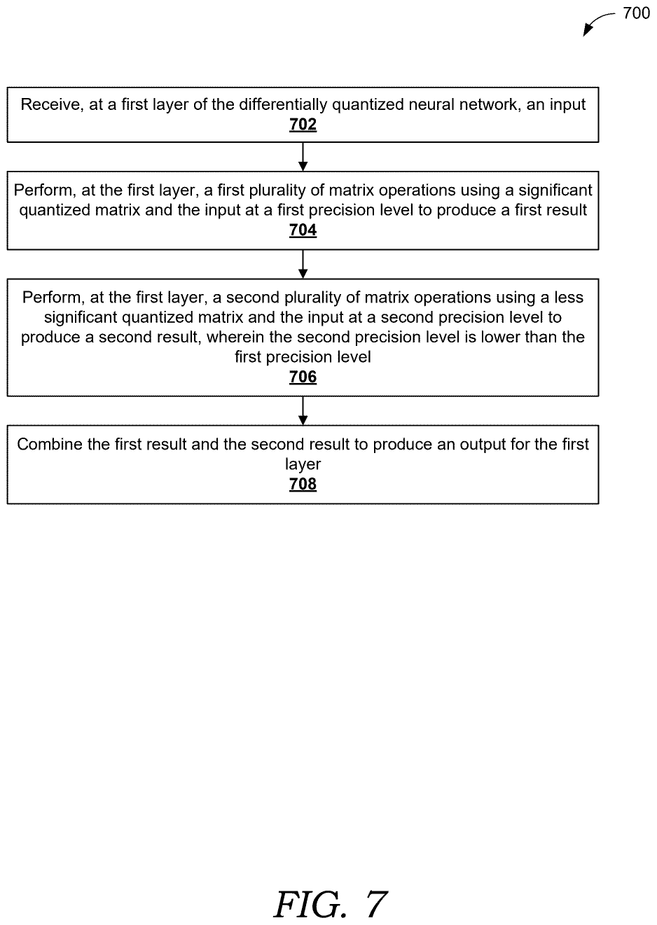

FIG. 7 is a flow diagram showing a method 700 of training a differentially quantized neural network, in accordance with some embodiments of the present disclosure. Method 700 may be performed on or with systems similar to those described with reference to FIGS. 1-4.

As shown in FIG. 7, process 700 may include training a neural network at a full precision quantization to form a partially trained neural network (block 702). Partially trained means that the model has undergone some training but has not yet reached a convergence or other stopping point. As also shown in FIG. 7, process 700 may include decomposing a weight matrix for a first layer of the partially trained neural network into an orthogonal matrix of singular values (block 704). Decomposition involves breaking down a matrix into a product of matrices, such as using Singular Value Decomposition (SVD). As further shown in FIG. 7, process 700 may include using the orthogonal matrix to identify a first row or column of matrix values that makes the largest contribution to performance of the partially trained neural network (block 706). As also shown in FIG. 7, process 700 may include forming a significant matrix using the first row or column of matrix values (block 708). As further shown in FIG. 7, process 700 may include forming a less significant matrix using a second plurality of columns and/or rows from the orthogonal matrix that does not include first row or column of matrix values (block 710). As also shown in FIG. 7, process 700 may include quantizing the significant matrix at a first precision level to form a significant quantized matrix (block 712). Quantization is the process of converting a number from a higher precision format to a lower precision format. As further shown in FIG. 7, process 700 may include quantizing the less significant matrix at a second precision level to form a less significant quantized matrix (block 714). As also shown in FIG. 7, process 700 may include including the significant matrix and the less significant matrix to form a partially trained differentially quantized neural network (block 716). As further shown in FIG. 7, process 700 may include training the differentially quantized neural network to form a quantized neural network (block 718). During back propagation, the quantized values of the partially trained quantized model 330 may be updated while maintaining the quantized precision. As also shown in FIG. 7, process 700 may include deploying the quantized neural network to a client device (block 720).

Although FIG. 7 shows example blocks of process 700, in some implementations, process 700 may include additional blocks, fewer blocks, different blocks, or differently arranged blocks than those depicted in FIG. 7. Additionally, or alternatively, two or more of the blocks of process 700 may be performed in parallel.

### Example Operating Environment

Referring to the drawings in general, and initially to FIG. 8 in particular, an example operating environment for implementing aspects of the technology described herein is shown and designated generally as computing device 800. Computing device 800 is but one example of a suitable computing environment and is not intended to suggest any limitation as to the scope of use of the technology described herein. Neither should the computing device 800 be interpreted as having any dependency or requirement relating to any one or combination of components illustrated.

The technology described herein may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. The technology described herein may be practiced in a variety of system configurations, including handheld devices, consumer electronics, general-purpose computers, specialty computing devices, etc. Aspects of the technology described herein may also be practiced in distributed computing environments where tasks are performed by remote-processing devices that are linked through a communications network.

With continued reference to FIG. 8, computing device 800 includes a bus 810 that directly or indirectly couples the following devices: memory 812, one or more processors 814, one or more presentation components 816, input/output (I/O) ports 818, I/O components 820, and an illustrative power supply 822. Bus 810 represents what may be one or more busses (such as an address bus, data bus, or a combination thereof). Although the various blocks of FIG. 8 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors hereof recognize that such is the nature of the art and reiterate that the diagram of FIG. 8 is merely illustrative of a computing device that may be used in connection with one or more aspects of the technology described herein. Distinction is not made between such categories as “workstation,” “server,” “laptop,” “handheld device,” etc., as all are contemplated within the scope of FIG. 8 and refer to “computer” or “computing device.”

Computing device 800 typically includes a variety of computer-readable media. Computer-readable media may be any available media that may be accessed by computing device 800 and includes both volatile and nonvolatile, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules, or other data.

Computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer storage media does not comprise a propagated data signal.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media.

Memory 812 includes computer storage media in the form of volatile and/or nonvolatile memory. The memory 812 may be removable, non-removable, or a combination thereof. Example memory includes solid-state memory, hard drives, optical-disc drives, etc. Computing device 800 includes one or more processors 814 that read data from various entities such as bus 810, memory 812, or I/O components 820. Presentation component(s) 816 present data indications to a user or other device. Example presentation components 816 include a display device, speaker, printing component, vibrating component, etc. I/O ports 818 allow computing device 800 to be logically coupled to other devices, including I/O components 820, some of which may be built in.

Illustrative I/O components include a microphone, joystick, game pad, satellite dish, scanner, printer, display device, wireless device, a controller (such as a stylus, a keyboard, and a mouse), a natural user interface (NUI), and the like. In aspects, a pen digitizer (not shown) and accompanying input instrument (also not shown but which may include, by way of example only, a pen or a stylus) are provided to digitally capture freehand user input. The connection between the pen digitizer and processor(s) 814 may be direct or via a coupling utilizing a serial port, parallel port, and/or other interface and/or system bus known in the art. Furthermore, the digitizer input component may be a component separated from an output component such as a display device, or in some aspects, the usable input area of a digitizer may coexist with the display area of a display device, be integrated with the display device, or may exist as a separate device overlaying or otherwise appended to a display device. All such variations, and any combination thereof, are contemplated to be within the scope of aspects of the technology described herein.

An NUI processes air gestures, voice, or other physiological inputs generated by a user. Appropriate NUI inputs may be interpreted as ink strokes for presentation in association with the computing device 800. These requests may be transmitted to the appropriate network element for further processing. An NUI implements any combination of speech recognition, touch and stylus recognition, facial recognition, biometric recognition, gesture recognition both on screen and adjacent to the screen, air gestures, head and eye tracking, and touch recognition associated with displays on the computing device 800. The computing device 800 may be equipped with depth cameras, such as stereoscopic camera systems, infrared camera systems, RGB camera systems, and combinations of these, for gesture detection and recognition. Additionally, the computing device 800 may be equipped with accelerometers or gyroscopes that enable detection of motion. The output of the accelerometers or gyroscopes may be provided to the display of the computing device 800 to render immersive augmented reality or virtual reality.

A computing device may include a radio 824. The radio 824 transmits and receives radio communications. The computing device may be a wireless terminal adapted to receive communications and media over various wireless networks. Computing device 800 may communicate via wireless policies, such as code division multiple access (“CDMA”), global system for mobiles (“GSM”), or time division multiple access (“TDMA”), as well as others, to communicate with other devices. The radio communications may be a short-range connection, a long-range connection, or a combination of both a short-range and a long-range wireless telecommunications connection. When we refer to “short” and “long” types of connections, we do not mean to refer to the spatial relation between two devices. Instead, we are generally referring to short range and long range as different categories, or types, of connections (i.e., a primary connection and a secondary connection). A short-range connection may include a Wi-Fi® connection to a device (e.g., mobile hotspot) that provides access to a wireless communications network, such as a WLAN connection using the 802.11 protocol. A Bluetooth connection to another computing device is a second example of a short-range connection. A long-range connection may include a connection using one or more of CDMA, GPRS, GSM, TDMA, and 802.16 policies.

### Embodiments

The technology described herein has been described in relation to particular aspects, which are intended in all respects to be illustrative rather than restrictive. While the technology described herein is susceptible to various modifications and alternative constructions, certain illustrated aspects thereof are shown in the drawings and have been described above in detail. It should be understood, however, that there is no intention to limit the technology described herein to the specific forms disclosed, but on the contrary, the intention is to cover all modifications, alternative constructions, and equivalents falling within the spirit and scope of the technology described herein.

What is claimed is:

1. One or more computer storage media comprising computer-executable instructions that when executed by computing device performs a method of generating a differentially quantized neural network, the method comprising:
decomposing a matrix from a first layer of a neural network into an orthogonal matrix of singular values;
identifying a first plurality of significant columns and/or rows in the orthogonal matrix that make above a threshold contribution to producing an accurate final inference;
forming a significant matrix using the first plurality of significant columns and/or rows;
forming a less significant matrix using a second plurality of columns and/or rows from the orthogonal matrix that are not in the first plurality of significant columns and/or rows;
quantizing the significant matrix at a first precision level to form a significant quantized matrix;
quantizing the less significant matrix at a second precision level to form a less significant quantized matrix; and
generating the differentially quantized neural network from the significant matrix and the less significant matrix.

2. The media of claim 1, wherein the threshold contribution is based on a threshold decrease in a neural network accuracy metric caused by removal of the columns and/or rows.

3. The media of claim 1, wherein the first precision level is higher than the second precision level.

4. The media of claim 1, wherein the first precision level is a floating-point precision and the second precision level is an integer precision.

5. The media of claim 1, wherein the quantizing the significant matrix is performed with an asymmetric quantization method.

6. The media of claim 1, wherein the first plurality of significant columns and/or rows include less than 10% of columns and/or rows in the orthogonal matrix.

7. The media of claim 6, wherein the decomposing is performed using a Singular Value Decomposition.

8. A method of operating a differentially quantized neural network comprising:
receiving, at a first layer of the differentially quantized neural network, an input;
performing, at the first layer, a first plurality of matrix operations using a significant quantized matrix and the input at a first precision level to produce a first result;
performing, at the first layer, a second plurality of matrix operations using a less significant quantized matrix and the input at a second precision level to produce a second result, wherein the second precision level is lower than the first precision level; and
combining the first result and the second result to produce an output for the first layer.

9. The method of claim 8, wherein the significant quantized matrix is identified by a decomposition of a first layer matrix.

10. The method of claim 9, wherein the decomposition of the first layer matrix is performed using a Singular Value Decomposition.

11. The method of claim 8, further comprising, prior to performing the first plurality of matrix operations, quantizing the input to the first precision level.

12. The method of claim 8, wherein the output for the first layer is an activation vector and includes a first set of values in the first precision level and a second set of values in the second precision level.

13. The method of claim 8, wherein the less significant quantized matrix includes more than twice an amount of values as found in the significant quantized matrix.

14. The method of claim 8, wherein the differentially quantized neural network is a large language model.

15. The method of claim 8, wherein the first precision level is a floating-point format and the second precision level is an integer format.

16. A method training a differentially quantized neural network, comprising:
training a neural network at a full precision quantization to form a partially trained neural network;
decomposing a weight matrix for a first layer of the partially trained neural network into an orthogonal matrix of singular values;
using the orthogonal matrix to identify a first row or column of matrix values that makes a largest contribution to performance of the partially trained neural network;
forming a significant matrix using the first row or column of matrix values;
forming a less significant matrix using a second plurality of columns and/or rows from the orthogonal matrix that does not include first row or column of matrix values;
quantizing the significant matrix at a first precision level to form a significant quantized matrix;
quantizing the less significant matrix at a second precision level to form a less significant quantized matrix;
including the significant matrix and the less significant matrix to form a partially trained differentially quantized neural network;
training the differentially quantized neural network to form a quantized neural network; and
deploying the quantized neural network to a client device.

17. The method of claim 16, wherein the quantizing the significant matrix is performed with an asymmetric quantization method.

18. The method of claim 16, wherein the first precision level is a floating-point precision and the second precision level is an integer precision.

19. The method of claim 16, wherein the second plurality of columns and/or rows from the orthogonal matrix include more than 80% of columns and/or rows in the orthogonal matrix.

20. The method of claim 16, wherein second plurality of columns and/or rows from the orthogonal matrix include more than 95% of columns and/or rows in the orthogonal matrix.
